(19) United States
(12) Patent Application Publication
(10) Pub. No.: US 2006/0093426 A1
(43) Pub. Date: May 4, 2006

(54) Compressible spill-proof container

(76) Inventor: Garry Tsaur, Rowland Heights, CA (US)

Correspondence Address: JOE NIEH, 18760 E. AMAR ROAD #204, WALNUT, CA, 91789, US

(21) Appl. No.: 10/982,046

(22) Filed: Nov. 4, 2004

(51) Int. Cl. B43M 11/06

(52) U.S. Cl. 401/184

(57) ABSTRACT

The compressible spill-proof container is a compressible single dose container that comprises of a compressible elongated container enclosing a substance with a viscous substance disposed therein between the substance and an open end of the compressible elongated container to prevent spillage and minimize evaporation of the substance. In another embodiment, the compressible spill-proof container further comprises of a restriction in the compressible elongated container with the viscous substance disposed at the restriction. A compressor for use with the compressible spill-proof container is further provided to easily compress the container to extract its contents.

The present invention relates generally to a small compressible container. More specifically, the present invention relates to a compressible single dose elongated container.

### BACKGROUND-DESCRIPTION OF RELATED ART

Various containers are used in the prior art to enclose and hold substances such as liquids and viscous substances. The containers may be in various sizes ranging from large water tanks to small single dose medicinal containers. The larger containers generally are relatively stable and spill-proof compare to small containers. Small containers also tend to be transported more often, subjecting to more shock and vibration, and are knocked over easily, spilling its contents.

Small containers may be provided with a cover, such as a screw-on cap to completely seal its contents and prevent spills during transport and storage. However, the addition of a cover increases the cost of the container and requires an additional step of opening the container prior to using its content. These shortcomings, particularly when the container is a single dose container, are not only inconvenient but may be cost prohibitive at times.

### BRIEF SUMMARY OF THE INVENTION

An object of the present invention is to provide a small spill-proof container that does not require a cover or any opening means such as a fracture line. Another object of the present invention is to enable a small spill-proof container to be manufactured economically and at a fast rate. Yet another object of the present invention is to provide a small compressible single dose spill-proof container that is convenient and easy to use. A further object of the present invention is to provide a compressor to be used with the compressible spill-proof container to easily extract the content of the container.

The compressible spill-proof container comprises of a compressible elongated container enclosing a substance with a viscous substance disposed therein between the substance and an open end of the compressible elongated container to prevent spillage and minimize evaporation of the substance. In another embodiment, the compressible spill-proof container further comprises of a restriction disposed in the compressible elongated container with the viscous substance disposed at the restriction. An optional compressor is also provided to enable compressing of the container with minimal effort to extract the contents of the container.

### BRIEF DESCRIPTION OF THE DRAWINGS

FIG. 1 shows the preferred embodiment of the compressible spill-proof container.

FIG. 2 shows another embodiment of the compressible spill-proof container.

FIG. 3 shows another embodiment of the compressible spill-proof container shown in FIG. 1.

FIG. 4 shows another embodiment of the compressible spill-proof container shown in FIG. 2.

FIG. 5 shows another embodiment of the compressible spill-proof container.

FIG. 6 shows a separate reusable compressor for use with the compressible spill-proof container.

### DETAILED DESCRIPTION OF THE PREFERRED EMBODIMENT

The following description and figures are meant to be illustrative only and not limiting. Other embodiments of this invention will be apparent to those of ordinary skill in the art in view of this description.

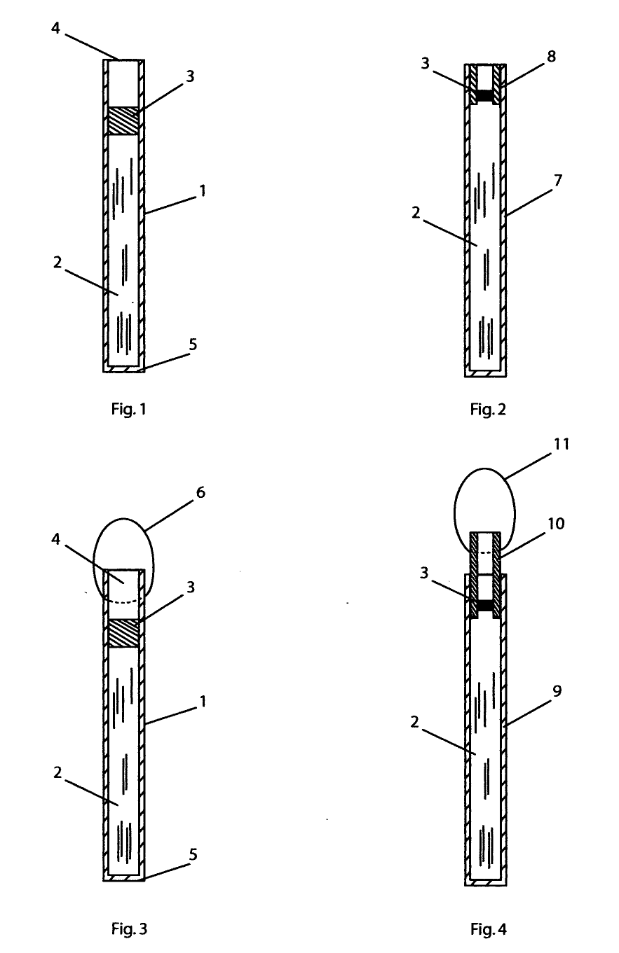

In the preferred embodiment, the compressible spill-proof container comprises of a compressible elongated container 1 enclosing a substance 2 with a viscous substance 3 disposed therein between the substance 2 and an open end 4 of the compressible elongated container 1 to prevent spillage and minimize evaporation of the substance 2 as shown in FIG. 1. The compressible elongated container 1 is preferably made of plastic such as polypropylene, or polyethylene. The compressible elongated container 1 has one open end 4 and a sealed end 5. A substance 2, such as a liquid or medication, is enclosed in the compressible elongated container 1 near the sealed end 5 of the container 1. A viscous substance 3, preferably silicone, is disposed in the compressible elongated container 1 between the substance 2 and the open end 4 of the container 1. The viscous substance 3 will function as a sealer and prevents the spilling of the substance 2 in the container 1 and also acts as a barrier to minimize evaporation of the substance 2 from the container 1. No additional cover or any opening means such as a fracture line is necessary.

The substance 2 in the compressible elongated container 1 is completely sealed in the container 1 by the compressible elongated container 1 and the viscous substance 3 prior to use. At the time of application, the container 1 only needs to be compressed, such as with the user's fingers, at the general position of the substance 2 to force the substance 2 in the compressible elongated container 1 through the viscous substance 3 to extract the substance 2 out from the open end 4 of the container 1. FIG. 3 shows another embodiment of the compressible spill-proof container wherein the open end 4 of the container 1 is surrounded or covered with an applicator tip 6. The applicator tip 6 may be an absorbent material such as cotton, foam, or sponge. The compressible elongated container 1 will effectively act as the applicator for the content of the container 1 after the substance 2 in the container 1 is compressed out of the container 1 into the applicator tip 6.

In another embodiment, the compressible spill-proof container comprises of a compressible elongated container 7 with a restriction 8 disposed in the compressible elongated container 7 and with a viscous substance 3 disposed at the restriction 8 enclosing a substance 2 in the compressible elongated container 7 to prevent spillage and minimize evaporation of the substance 2 as shown in FIG. 2. In this embodiment, the restriction 8 in the compressible elongated container 7 enables the compressible elongated container 7 to enclose larger amounts of the substance 2 by increasing its diameter without increasing its length. The restriction 8 will enable the viscous substance 3 to maintain its position at the restriction 8 and maintain its effectiveness in sealing the substance 2 in the container 7. Without the restriction 8, the viscous substance 3 will not be able to effectively hold the substance 2 in the container 7 when the diameter of the compressible elongated container 7 is enlarged past the viscous substance's 3 ability to hold itself together and maintain its position.

FIG. 4 shows another embodiment of the compressible spill-proof container wherein the restriction is formed by the affixation, such as by insertion, of another elongated tube 10 with a small inside diameter to the open end of the container 9. The elongated tube 10 is preferably made of a rigid plastic material such as polyethylene, polypropylene, nylon, or ABS. The free end of the elongated tube 10 is surrounded or covered with an applicator tip 11. The applicator tip 11 may be an absorbent material such as cotton, foam, or sponge. In this embodiment, the compressible elongated container 9 will effectively act as the applicator for the content of the container after the substance 2 in the container is compressed out of the container 9 into the applicator tip 11.

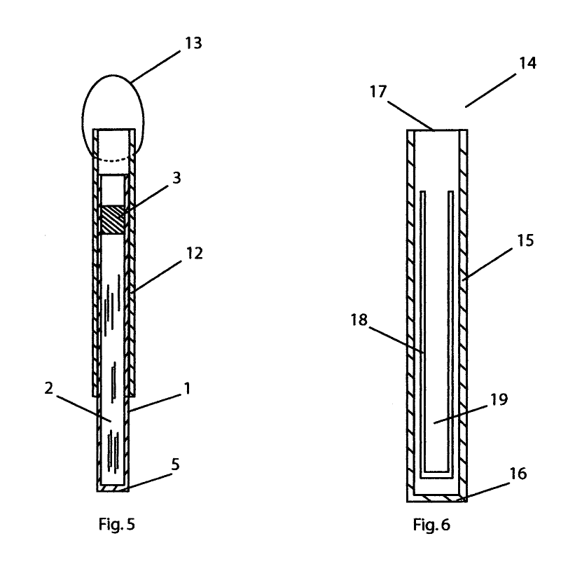

FIG. 5 shows another embodiment of the compressible spill-proof container. In this embodiment, the compressible spill-proof container as shown in FIG. 1 or 2 is inserted into a hollow tube 12. One end of the hollow tube 12 is surrounded or covered with an applicator tip 13. The applicator tip 13 may be an absorbent material such as cotton, foam, or sponge. In this embodiment, the substance 2 in the compressible elongated container 1 is compressed and extracted into the applicator tip 13 at the end of the hollow tube 12 for application. This embodiment enables multiple substances to be released into the applicator tip 13 for application.

An optional compressor 14, as shown in FIG. 6, may be used to enable easier compressing of the container 1 with minimal effort to extract the contents of the container 1. The compressor 14 is a simple tube 15, preferably with a sealed end 16 and an open end 17. The tube 15 is formed with an elongated “U” shaped cut 18 resulting in a long flexible tab 19 that can be pushed into the tube 15 with the fingers. The flexible tab 19 may further be provided with a raised portion that protrudes above the surface of the tube 15 to allow easier and more compression when it is pushed inward. The compressible spill-proof container, such as the ones shown in FIGS. 1 and 2, is inserted into the compressor 14 with the substance 2 positioned under the flexible tab 19. The flexible tab 19 is then pushed in with the fingers to easily compress the compressible spill-proof container to extract its contents.

An optional elongated member may also be affixed within the compressible elongated container 1 to enable positive and rapid extraction of the substance 2 in the container 1 after the viscous substance 3 seal is ruptured by compressing the compressible elongated container 1. The elongated member may be affixed to the sealed end 5 of the compressible elongated container 1. The elongated member will disrupt the surface tension and increase the capillary action of the substance 2 to enable it to flow out of the compressible elongated container 1 rapidly.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. A compressible spill-proof container comprising:
a compressible elongated container with an open end;
a substance disposed in said compressible elongated container; and
a viscous substance disposed between said substance and an open end of said compressible elongated container;
whereby the compressible spill-proof container will prevent spillage and minimize evaporation of said substance.

2. A compressible spill-proof container as in claim 1, wherein said compressible elongated container is made of plastic.

3. A compressible spill-proof container as in claim 2, wherein said compressible elongated container is made of polypropylene or polyethylene.

4. A compressible spill-proof container as in claim 1, wherein said viscous substance is silicone.

5. A compressible spill-proof container as in claim 1, wherein said open end of said compressible elongated container is covered with an applicator tip.

6. A compressible spill-proof container as in claim 5, wherein said applicator tip is an absorbent material such as cotton, foam, or sponge.

7. A compressible spill-proof container comprising:
a compressible elongated container with an open end;
a restriction disposed in said compressible elongated container;
a substance disposed in said compressible elongated container; and
a viscous substance disposed at or near said restriction between said substance and an open end of said compressible elongated container.

8. A compressible spill-proof container as in claim 7, wherein said restriction is formed by the affixation of an elongated tube with a small inside diameter to said open end of said compressible elongated container.

9. A compressible spill-proof container as in claim 7, wherein said compressible elongated container is made of plastic.

10. A compressible spill-proof container as in claim 9, wherein said compressible elongated container is made of polypropylene or polyethylene.

11. A compressible spill-proof container as in claim 7, wherein said viscous substance is silicone.

12. A compressible spill-proof container as in claim 7, wherein said open end of said compressible elongated container is covered with an applicator tip.

13. A compressible spill-proof container as in claim 12, wherein said applicator tip is an absorbent material such as cotton, foam, or sponge.

14. A compressible spill-proof container as in claim 8, wherein an end of said elongated tube is covered with an applicator tip.

15. A compressible spill-proof container as in claim 14, wherein said applicator tip is an absorbent material such as cotton, foam, or sponge.

16. A compressible spill-proof container as in claim 1, wherein a compressor comprising a tube with an elongated “U” shaped cut resulting in a long flexible tab is provided to compress the compressible elongated container.

17. A compressible spill-proof container as in claim 16, wherein said flexible tab is further provided with a raised portion that protrudes above the tube.

18. A compressible spill-proof container as in claim 1, wherein an elongated member is affixed within said compressible elongated container.

19. A compressible spill-proof container as in claim 18, wherein said elongated member is affixed to a sealed end of said compressible elongated container.

20. A compressible spill-proof container as in claim 7, wherein an elongated member is affixed within said compressible elongated container.
